(19) United States
(12) Patent Application Publication
(10) Pub. No.: US 2015/0151855 A1
(43) Pub. Date: Jun. 4, 2015

(54) SYSTEM AND METHOD FOR MULTI-ROLE PLANETARY LANDER AND ASCENT SPACECRAFT

(71) Applicant: Moon Express, Inc., Moffett Field, CA (US)

(72) Inventors: Robert David Richards, San Jose, CA (US); Timothy Leon Pickens, Madison, AL (US); Michael David Vergalla, Mountain View, CA (US)

(21) Appl. No.: 14/472,347

(22) Filed: Aug. 28, 2014

Related U.S. Application Data
(60) Provisional application No. 61/871,266, filed on Aug. 28, 2013.

(51) Int. Cl. B64G 1/40; B64G 1/24

(52) U.S. Cl. CPC B64G 1/402; B64G 1/24; B64G 1/401

(57) ABSTRACT

A spacecraft for various missions such as moon landing, space station or asteroid rendezvous, or payload delivery. The spacecraft comprises a main propellant tank, preferably toroidal in shape, that also serves as the primary structural component of the spacecraft. The spacecraft's secondary structures such as a second propellant tank, pressurant tanks, engines, and payload deck are attached directly to the main propellant tank. The spacecraft has a substantially circularly symmetric weight distribution about its centerline,

The spacecraft can be configured to be monopropellant; alternatively, in a bipropellant configuration the spacecraft includes a second propellant tank, which can carry a fuel such as kerosene or ethanol and if toroidal preferably nests together with the main propellant tank. In some configurations the propulsion system can switch between monopropellant operation and bipropellant operation, and automatically switches to monopropellant operation once one of the propellants is deleted. In either configuration the main propellant is preferably high-test peroxide. The shape of the spacecraft preferably fits into the circular inner wall of a housing for mounting within a launch vehicle, thereby optimizing launch vehicle payload volume and facilitating stacking of multiple housings in the launch vehicle.

### CROSS-REFERENCE TO RELATED APPLICATIONS

This application claims priority to and the benefit of filing of U.S. Provisional Patent Application Ser. No. 61/871,266, entitled “System and Method for Multi-Role Planetary Lander and Ascent Spacecraft”, filed on Aug. 28, 2013, the specification and claims of which are incorporated herein by reference.

### BACKGROUND OF THE INVENTION

1. Field of the Invention (Technical Field):

The present invention relates to a type of spacecraft that comprises a toroidal propellant tank as the central design element that enables it to serve in multiple roles to fulfill the relevant phases of certain space missions. The spacecraft design is simple rather than complex, capable of operating in modes mono-propellant or bi-propellant on the main engine, provides a high density impulse, and enables efficient low profile packaging in single- or multiple-unit stacked configuration on a wide variety of host launch vehicles, while ensuring efficient in-flight operation and low risk delivery of payloads, with inherent static and dynamic stability advantages over existing state of the art designs, and more efficient use and management of propellants over convention thrust vector-based attitude control systems, among other benefits.

2. Background Art:

Note that the following discussion may refer to a number of publications and references. Discussion of such publications herein is given for more complete background of the scientific principles and is not to be construed as an admission that such publications are prior art for patentability determination purposes.

Spacecraft have been under cyclic phases of research, development, design, manufacture, test, deployment and operation for over six decades, both manned and robotic. Placement of spacecraft into a variety of orbits around the earth rapidly led to manned missions to the moon, with robotic missions extending further into our solar system and beyond. Spacecraft design generally follows a set of basic rules, giving treatment to well understood, yet evolving, engineering expertise of propulsion, systems, control, mechanical, thermal, electrical, computer and other disciplines. Configurations have taken on a variety of form factors that are typically functionally matched to the mission design.

Spacecraft designed for mission profiles that include landing and departure from the surface of planetary bodies invoke a specific set of requirements that typically dwarf in complexity those of spacecraft whose useful life is spent in orbit around planetary bodies or along mission-specific flight paths that do not include physical contact with moving bodies. Spacecraft designed for landing on, or attaching to, bodies in space, and their subsequent ascent, or departure, from such bodies, as well as the precise placement of such spacecraft in free space executing the subsequent release of payloads into highly specific orbits or trajectories, is specific to the nature of the invention presented herein.

### SUMMARY OF THE INVENTION (DISCLOSURE OF THE INVENTION)

The present invention is a spacecraft for which the primary structural component comprises a propellant tank for carrying a first propellant. The propellant tank is preferably toroidal. The spacecraft preferably comprises one or more secondary structures selected from the group consisting of a second propellant tank, one or more pressurant tanks, a main engine, a payload deck, and one or more attitude control engines: wherein aid secondary structures are attached directly to the propellant tank. The attitude control engines are preferably operated via pulse width modulation. The spacecraft preferably comprises a substantially circularly symmetric weight distribution about its centerline. The spacecraft preferably comprises a single stage propulsive system. The propellant tank is preferably designed to carry high-test peroxide. The spacecraft can comprise a monopropellant propulsion system, or alternatively a bipropellant propulsion system including a second propellant tank for carrying a second propellant which preferably comprises kerosene or ethanol. The second propellant tank is preferably toroidal and preferably concentrically nests together with the propellant tank. The second propellant tank is preferably attached below the propellant tank and preferably has a circumference greater than that of the propellant tank. The first propellant optionally comprises an oxidizer and the second propellant optionally comprises a fuel, in which case the bipropellant propulsion system operates at an oxidizer to fuel mixture ratio that is preferably greater than approximately three to one, and more preferably greater than approximately six to one. The propulsion system is preferably switchable between monopropellant operation and bipropellant operation, and preferably automatically switches to monopropellant operation after depletion of one of the propellants such as a fuel. The spacecraft preferably comprises an outer mold line that mates with a circular inner wall of a housing for mounting within a launch vehicle, thereby optimizing launch vehicle payload volume and facilitating stacking of multiple housings in the launch vehicle. The propellant tank and/or the second propellant tank preferably comprises a composite material.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate embodiments of the present invention and, together with the description, serve to explain the principles of the invention. The drawings are only for the purpose of illustrating certain embodiments of the invention and are not to be construed as limiting the invention. In the drawings:

FIGS. 1A and 1B are perspective and cutaway views respectively of the main toroidal propellant tank and attachment points thereon isolated from the rest of the spacecraft.

FIGS. 2A and 2B are perspective and cutaway views respectively showing the attachment of the propulsion system to the main toroidal propellant tank of FIG. 1.

FIGS. 3A and 3B are perspective and cutaway views respectively showing the attachment of the payload deck to the main toroidal propellant tank and propulsion system of FIG. 2.

FIGS. 4A and 4B are perspective and cutaway views showing integration of solar panels and communications with the payload deck and main toroidal propellant tank of FIG. 3, which serves as the main structural component of an embodiment of the spacecraft of the present invention.

FIGS. 5A and 5B are front and perspective cutaway views respectively showing an embodiment of the spacecraft of the present invention installed within a launch vehicle shroud.

FIGS. 6A and 6B are front and perspective cutaway views respectively showing a plurality of stacked spacecraft of the present invention installed within a launch vehicle shroud.

FIGS. 7A and 7B show static load analysis and modal analysis results of the structural strength of the toroidal tank.

FIGS. 8A and 8B are top and bottom perspective depictions of an embodiment of a spacecraft of the present invention.

FIGS. 9A and 9B show two views of an embodiment spacecraft propulsion system.

FIG. 10 is an exploded view primary and secondary spacecraft structures.

FIG. 11 is a view of an embodiment payload deck comprising payloads and avionics.

FIG. 12 depicts a spacecraft of the present invention within a dual (or secondary) payload adaptor system of a host launch vehicle.

FIG. 13 depicts a separation mechanism.

### DETAILED DESCRIPTION OF THE INVENTION

Embodiments of the present invention are spacecraft whose mission preferably revolves around the landing and ascent from the lunar surface or other planetary bodies. Such a spacecraft is also particularly well suited for missions making temporary physical contact with other non-planetary bodies or objects in space, including, but not limited to, asteroids, or man-made objects such as other spacecraft, orbiting satellites or space stations, such as the International Space Station. Additionally, such a spacecraft is particularly well suited to the insertion of payloads into highly precise orbits, positions in space, or trajectories. The market segments inside of which the current invention is particularly well suited is lunar or planetary landing and ascent; lunar or planetary transportation; space debris dean-up; asteroid intercept or trajectory adjustment; and satellite maintenance, retrieval or orbit adjustment. Those well versed in the state of the art will recognize further unique applications for the spacecraft system presented herein, and use should not be considered limited to only those mission types characterized in this paragraph.

An embodiment of the spacecraft of the present invention blends the functionality of one major component of the spacecraft in order to provide significant benefits in a variety of other critical areas. The result is a spacecraft with improved mass fraction (ratio of total propellant mass to spacecraft mass), improved static and dynamic stability, a reduction in the number of required propulsion stages, increased real estate to carry customer payloads, efficient packaging on host launch vehicle, efficient stacking of multiple-unit systems on launch vehicle, overall system simplicity, reduced development and manufacturing costs, reduced total cost of ownership, and reduced cost of operation. Importantly, the current embodiment provides significant costs savings that can be passed to the payload customer by the operator of such spacecraft. And finally, the current embodiment comprises a spacecraft system with an overall simplicity of design that reduces program risk to commercial and public-sector customers overall.

Embodiments of the spacecraft of the present invention are based on a vehicle propellant tank which is preferably toroid shaped and designed to double as both the major structural element of the spacecraft as well as the pressure vessel which carries and facilitates movement of the propellant to the main and control engines. Such dual functionality of the propellant tank leads directly to an array of benefits and performance enhancements that bring value to the customers purchasing payload or related services.

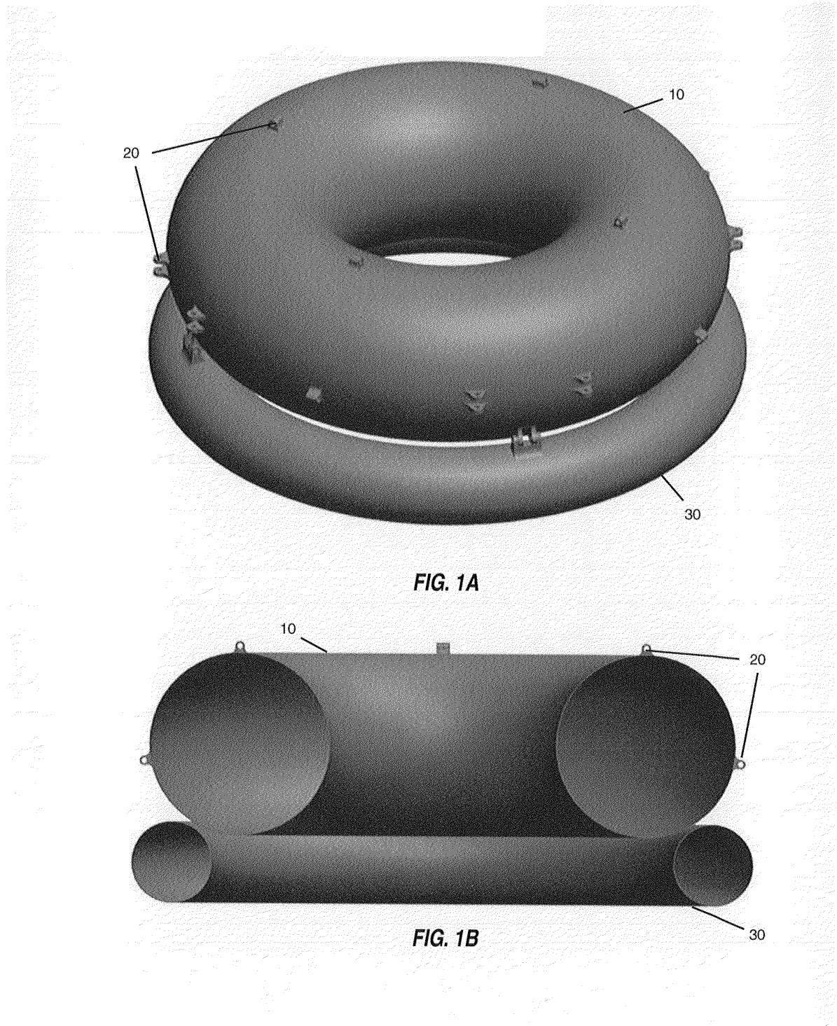

In FIGS. 1A and 1B, main propellant tank 10 is preferably toroidal comprises one or more attachment points 20, only some of which are shown in the figure, which provide a means for attaching and integrating the other components of the spacecraft, including fuel tank 30. Fuel tank 30 is also preferably toroidal and optionally comprises a diameter larger than that of main tank 10, allowing main tank 10 to nest within it. Main tank 10 preferably carries an oxidizer such as high test peroxide (“HTP”), and fuel tank 30 preferably carries fuel, such as kerosene. Together, main tank 10 and fuel tank 30 preferably serve as both the primary structural framework of the spacecraft as well as the means to carry propellant. Those versed in the state of the art will realize that a wide variety of oxidizers and fuels can be carried in a toroidal tank design, accommodating a wide range of mixture ratios through scaling of either tank, or even adding additional tanks (not shown) to accommodate more advance propellants or providing for the carriage of propellant in multiple tanks instead of one. For a single propellant (monoprop) spacecraft a separate fuel tank is typically not required, and in some bipropellant embodiments the fuel or a second propellant can be stored in one or more tanks which may be toroidal or comprise any shape, which tanks preferably attach to main tank 10.

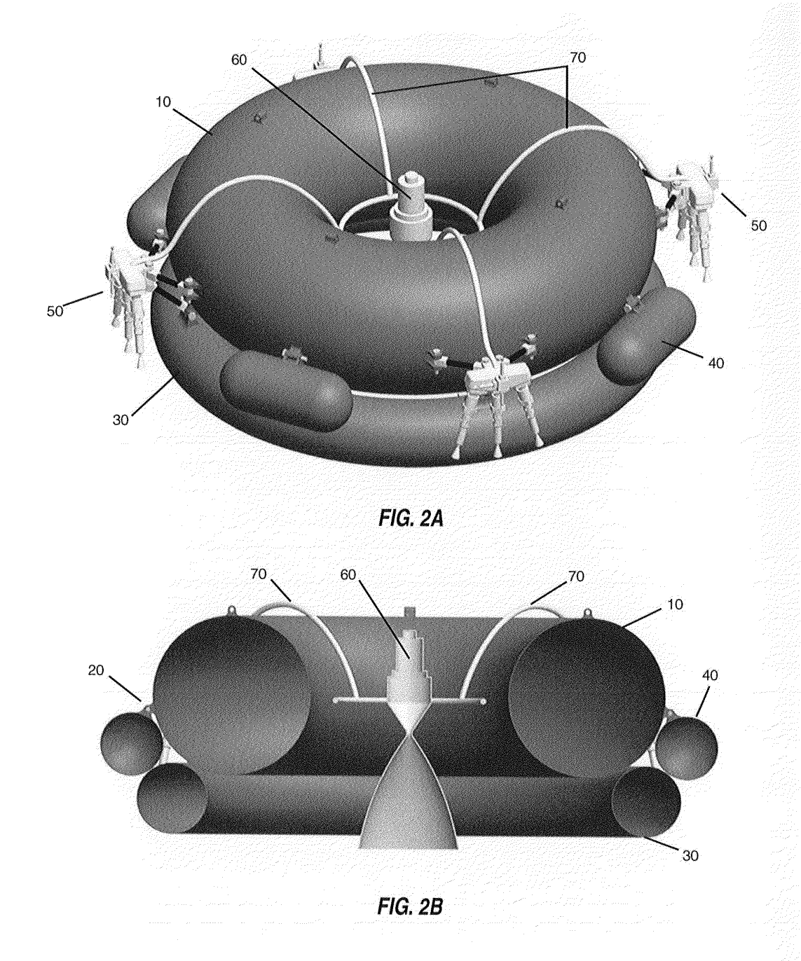

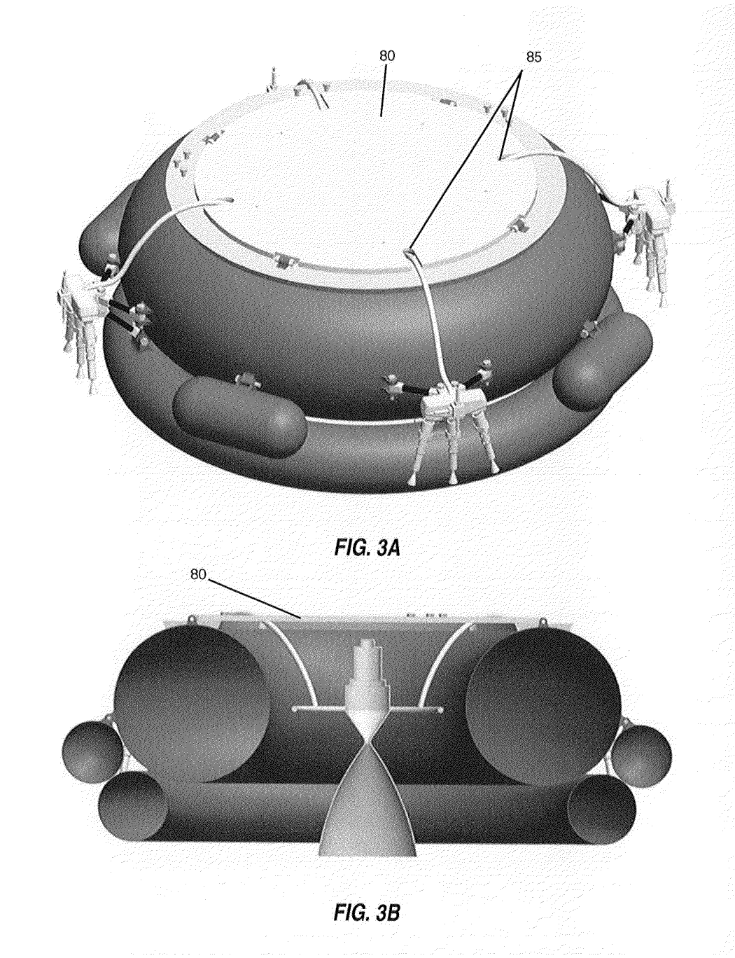

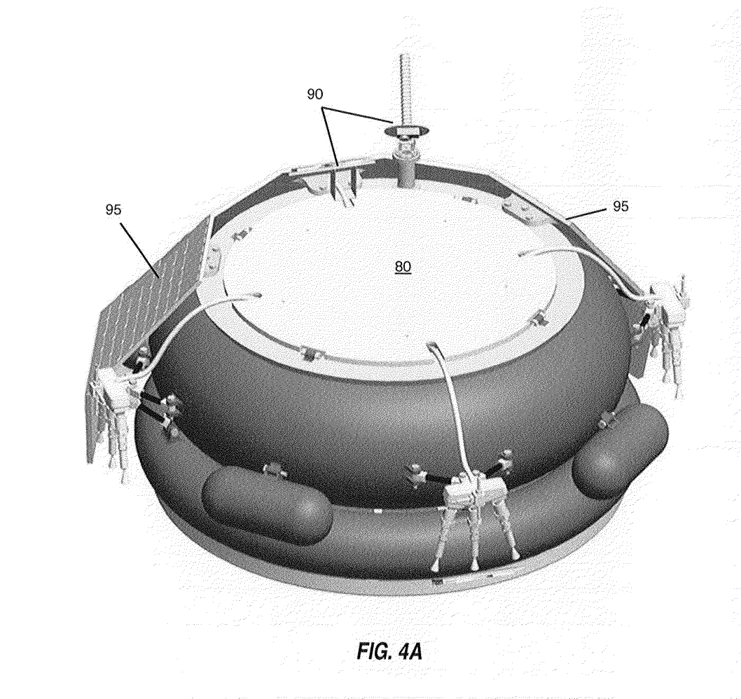

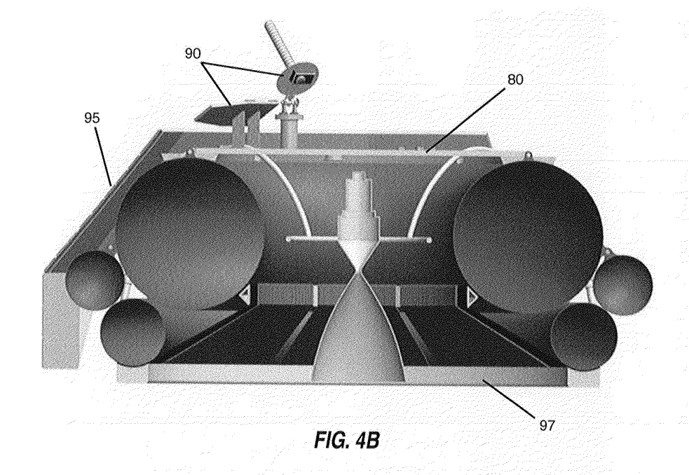

FIGS. 2A and 28 show main tank 10, fuel tank 30, attachment points 20, and one or more pressurant tanks 40 which preferably carry high pressure helium or nitrogen, which is used for pressurizing main tank 10 and fuel tank 30 through a series of valves and lines (not shown), thereby transferring propellants through propellant delivery lines 70 to one or more optional attitude control engines 50 and main engine 60. The engines are preferably attached directly to main tank 10. FIGS. 3A and 38 further shows payload deck 80, preferably attached to main tank 10 on the side opposite that of fuel tank 30, which provides a platform on top of which a variety of equipment and customer payloads can be positioned and attached. Payload deck 80 optionally comprises cutouts 85 to accommodate the placement of propellant delivery lines 70, FIGS. 4A and 4B show the placement of communications hardware 90 on payload deck 80, which hardware is necessary to establish a bidirectional high rate data link to Earth and other points, and solar panels 95 that provide a solar recharge capability to onboard batteries (not shown) and other subsystems (not shown). As can be seen, all major components of the spacecraft preferably attach to main tank 10. Optional device 97 absorbs the energy of impact during landing events.

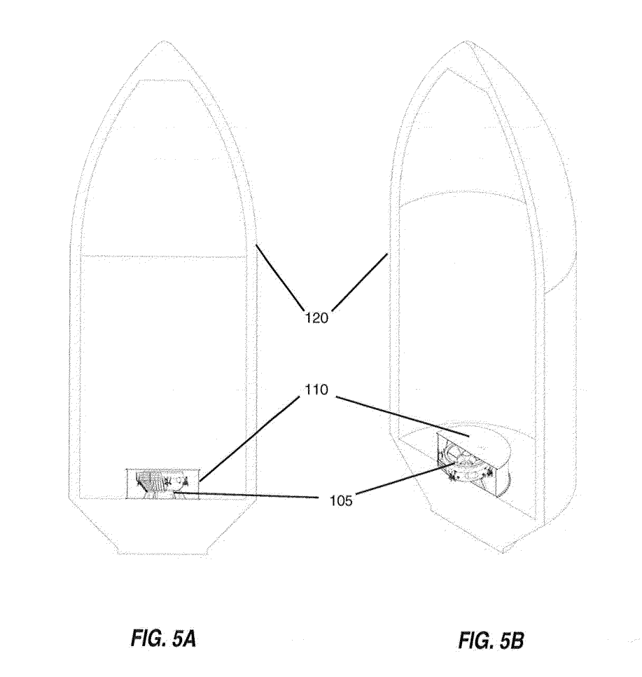

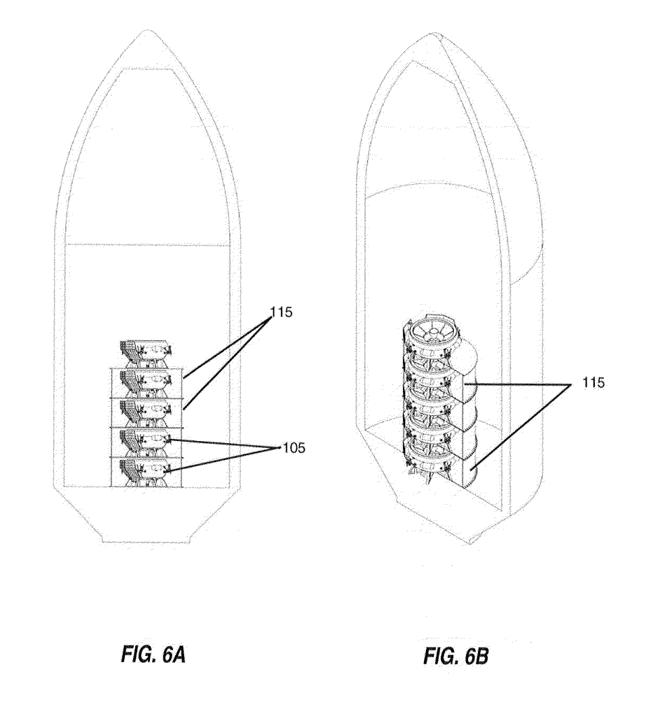

FIGS. 5A AND 5B shows spacecraft 105 as a system installed within adaptor ring 110 of host launch vehicle 120. Multiple adaptor rings 115 can be stacked to accommodate a plurality of spacecraft as shown in FIGS. 6A and 68.

The toroidal propellant tank of the present invention preferably provides improved mass fraction, which is defined as the ratio of propellant mass to total mass of the spacecraft (including propellant, structure, all subsystems and payload). In the conventional design of spacecraft of the family in which the current spacecraft falls, typical propellant tanks do not typically double as a major structural component of the spacecraft and instead are captured within a secondary structural framework that supports the tanks. Propellant tanks are often spherical in shape, or of some other non-conformal geometry, such that, while possessing other advantages, fail to optimize the available volume of the spacecraft as a system, result in a comparatively lower mass fraction, and possess little optimization for fitting into restrictive space onboard host launch vehicles. In the present invention, mass fraction translates to efficiency and therefore lower costs of operation and lower price points for customers fielding a fleet of such spacecraft in for-profit commerce.

Another major benefit of the embodiment of the present invention in which the toroidal tank doubles as a pressure vessel and major structural element is that the spacecraft is substantially symmetric about its centerline and therefore offers a significant reduction in center of gravity excursions due to both the depletion and slosh of propellants throughout the spacecraft's mission. While controllable to some degree in any conventional tank design and configuration through a variety of techniques, a change in center gravity is never eliminated. As the spacecraft consumes its propellant, its mass properties change. Depending on the shape and location of the propellant tanks about the spacecraft's reference geometric centerline, the center of gravity typically moves. In the case of spherical tanks offset from the centerline, and lacking symmetry in the distribution of such tanks, the center of gravity will shift significantly Additionally, as propellants are depleted and tank overhead, or ullage, is created, propellants will have the freedom to dynamically shift, causing the center of gravity to dynamically move in turn, thereby creating time-varying mass imbalances. In either case, the effects of a time-varying center of gravity must be captured and nulled by the spacecraft attitude control system. For conventional spacecraft with tank configurations that hold propellants that are significantly offset from the spacecraft main axis, and otherwise lack the symmetry offered by toroidal tank selection, the time varying mass imbalances are more pronounced and therefore require higher control authority to null them. Higher control authority is conventionally achieved through dynamically adjusting the direction of the thrust vector of the main engine by employing one or several actuators that are driven by a control system within the on-board guidance, navigation and control system.

Due to the geometric symmetry about the spacecraft centerline in embodiments of the present invention, the center of gravity shift due to propellant depletion and propellant are significantly smaller on a relative basis, and the net result is that less control authority is required to ensure stability This allows for the use of a less complex, lighter, more reliable attitude control system comprised of multiple distributed fixed attitude control nozzles instead of thrust vector direction actuators. Because such an attitude control system is isolated from the main engine, it can be activated on demand in a mode known to those versed in the art as pulse width modulation. Pulse width modulation offers advantages over conventional thrust vector control in that such on/off operations can be configured to consume propellant more efficiently, provides more precise control, and is simpler, more reliable and of less mass in aggregate when compared to the hardware necessary to implement a standard thrust vectoring attitude control system. Additionally, such an attitude control system allows the spacecraft to operate at lower thrust levels with more precision velocity control.

Embodiments of the present invention comprise twelve attitude control engines that serve to steer the spacecraft when the main engine is firing. The spacecraft in the figures show attitude control engines in four clusters of three fixed nozzles each. However, other configurations are possible, with fewer or more clusters and fewer or more fixed nozzles, all capable of achieving a similar means of control of varying fidelity. The attitude control engines can be fired in pairs of 2, 4, 6, 8, 10 or 12, in different combinations to allow for small levels of Vernier thrust to enable precise velocity control. Another advantage is in the system's ability to achieve velocity constant during critical flight regimes, such as final descent approaching touchdown. Pulse width modulation, ultimately, uses propellant more efficiently than a conventional engine that incorporates throttling and gimbaled thrust vectoring of the main engine as a means of attitude and velocity control. Even with a lower specific impulse of the attitude control engines running in monopropellant mode, there are significant advantages in the use and management of propellants, making it a more efficient design overall.

The use of a toroidal tank preferably results in the spacecraft having an improved mass fraction as a result of optimized geometry. Mass fraction is further indirectly improved through the reduced center of gravity excursion inherent in the toroidal tank configuration, which, in turn, eliminates the mass consumptive thrust vectoring systems in favor of a fixed nozzle attitude control system. As a result of improved mass fraction overall, the spacecraft of the current embodiment is advantageously reduced to a single propulsive stage system, eliminating the complexity and cost inherent in a multistage propulsion system otherwise required to meet the performance requirements of the various phases of the mission, specifically braking, attitude controlled cruise, and landing. Stated another way, the toroidal propellant tank, doubling as the major structural element of spacecraft, directly and indirectly leads to the optimized use of available volume for the storage of propellant and eliminates other mass consumptive subsystems, thereby improving the mass fraction overall, and, in turn, allows the mission requirements to be met with a single stage propulsion system. The net effect of being able to leverage a single stage system is further reduced mass overall, reduced size, reduced complexity, lower risk, lower cost and a better value proposition to the paying customer contracting payload delivery services from the operator leveraging such system and methods in their spacecraft design.

The toroidal tank shape also facilitates the stacking of multiple tanks without loss of the inherent benefits cited herein. Such stacking of tanks, preferably within the outer mold line of the spacecraft itself, allows the extension of the baseline single-tank monopropellant configuration to a higher performance two-Lank bipropellant design. In its baseline monopropellant embodiment, the spacecraft of the present invention preferably comprises only a single propellant, such as high-Lest peroxide or HTP, which is a high (85 to 98 percent) concentration solution of hydrogen peroxide, in a single toroidal tank. When put in contact with a catalyst, such as stacked silver screens, manganese dioxide, or platinum, HTP decomposes into a high-temperature mixture of steam and oxygen, massively expanding through a nozzle and producing the desired thrust for both the main engine and aforementioned attitude control system. Common achievable specific impulses range from 130 to 150 seconds.

Other embodiments utilize two or more propellants or mixtures thereof. For example, the performance of the monopropellant configuration can be extended by introducing kerosene into the chamber, which auto-ignites upon mixing with the high temperature stream of decomposed HTP downstream of the silver screen catalyst, approximately doubling the specific impulse of the engine. Other fuels can be substituted, such as ethanol, and similar results may be achieved. To those well versed in the state of the art, it will be apparent that a wide range of fuels can be used to enhance the performance of monopropellant engine. The kerosene is preferably carried in a separate toroidal tank, in a stacked configuration such that the benefits outlined herein are maintained. In typical spacecraft designs, there exists an inherent design constraint driven by the need to maintain to the extent possible mass symmetry through the depletion of propellants. This has typically led to the use of propellants that burn at mixture ratios of one to one, in order to minimize the propellant depletion induced mass asymmetry. In the case of the toroidal tank shape of the present invention, because they are symmetric about the centerline of the vehicle, one need not burn fuel and oxidizer at mixture ratios of near one to one to avoid the introduction of mass asymmetries. In fact, certain embodiments herein, the mixture ratio of oxidizer mass (HTP) to fuel mass (kerosene) can range from six to one to as high as eight to one. Therefore the volume requirement of the kerosene tank is many times smaller than that of the toroidal tank carrying the HTP, once accounting for density variations. Regardless, the stacked toroidal layout configuration is maintained, with the smaller of the two tanks nested inside, aligned above or below, enveloping and offset from the plane of the other, while still maintaining the many inherent design benefits that come from the toroidal design.

The present invention optionally enables a selectable mode of operation, either in monopropellant or bipropellant mode, depending on performance needs and in accordance with schedule that is input into the control algorithms of on-board guidance, navigation and control systems. The unique nature of the toroidal tank design therefore extends benefit to the real-time selectable operation of monopropellant or bipropellant mode, while maintaining a high mass fraction, which in turn reduces the propulsive requirements to a single stage system, capable of driving a main engine and attitude control system in high performance bipropellant mode or lower performance monopropellant mode on an as-needed basis. The propulsion system preferably operates in both monopropellant and bipropellant modes, while the attitude control system preferably runs in monopropellant mode, maintaining simplicity of design and reducing risk of operation overall. The main engine typically preferably runs in bipropellant mode, mixing kerosene into the expanded HTP to achieve higher performance targets. However, the main engine need not run in bipropellant mode, and unlike conventional propellants used in bipropellant engines, the selection of HTP and kerosene allows the system to run to fuel depletion, whereby the engine can simply shift to operation in monopropellant mode. This artifact of event-free switchover from bipropellant mode to monopropellant mode upon fuel depletion has two main advantages. First, it avows for a flexible propellant budget, freeing the system up from perfect matching of fuel and oxidizer and therefore complexity and costly propellant management systems. Second, and potentially more importantly, since one can burn fuel to depletion and have a natural progression into monopropellant mode, the spacecraft is not subjected to the typically hazardous phase where the engine runs oxygen rich, and therefore hot, pushing the engine into areas of operations where high temperatures can cause a burn-through of the engine wall, or other potentially catastrophic issues connected with overheating. As the spacecraft nears its run to fuel depletion, it has the added advantage of requiring less performance due to its lighter weight resulting from the depletion of propellants overall. Therefore, switching to a less efficient monopropellant mode of operation does not affect performance overall. Lastly, because in an optional configuration of the present invention the fuel tank is attached to the to the lower outside portion of the main tank, once depleted of its propellant, the toroidal fuel tank serves as a structural element that is no longer doubling as an active fuel tank, thereby further mitigating certain mission risk elements.

The toroidal tank configuration also allows for efficient scaling of design, from systems capable of carry small payloads on the order of 20 kg, to larger systems with the ability to haul for commercial customers payloads in excess of 2,000 kg or more, without compromising the benefits presented herein. Furthermore the toroidal tank configuration results in enhanced packaging efficiency within the payload shrouds of a variety of host launch vehicles. The toroid is, by its very nature, conformal to the standardized shape of most every launch vehicle under consideration as a carrier to lunar orbit, or other points in space where operations are to be conducted. The circular outer mold line of the toroid matches well with the circular inner wall of a typical launch vehicle shroud, optimizing the use of launch vehicle payload volume. Likewise, the toroidal configuration lends itself to efficient vertical stacking of multiple spacecraft, maximizing the use of launch vehicle payload volume and thereby reducing the cost burden connected to purchasing launch services from a third party. The net result is a superiorly competitive price point offered to commercial customers by operators of the spacecraft embodied herein.

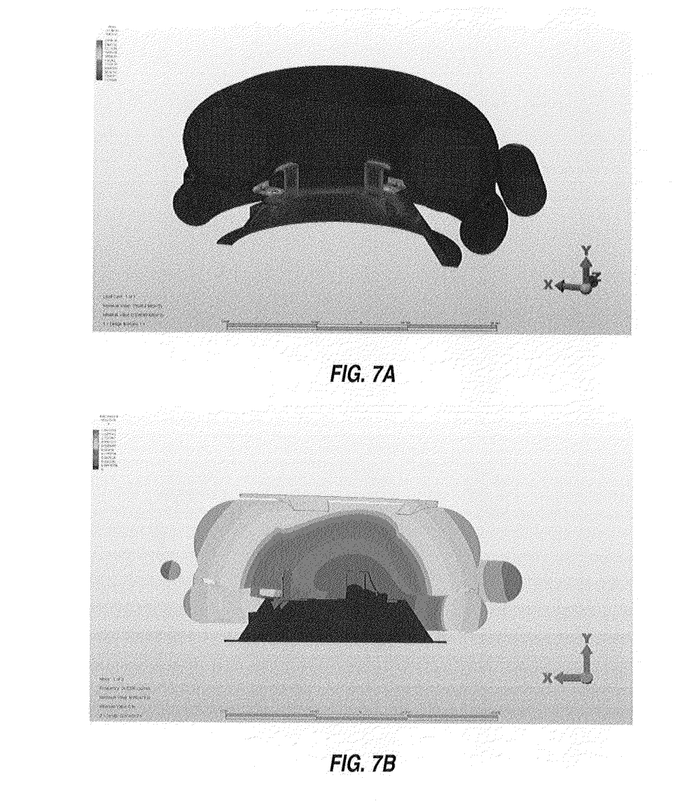

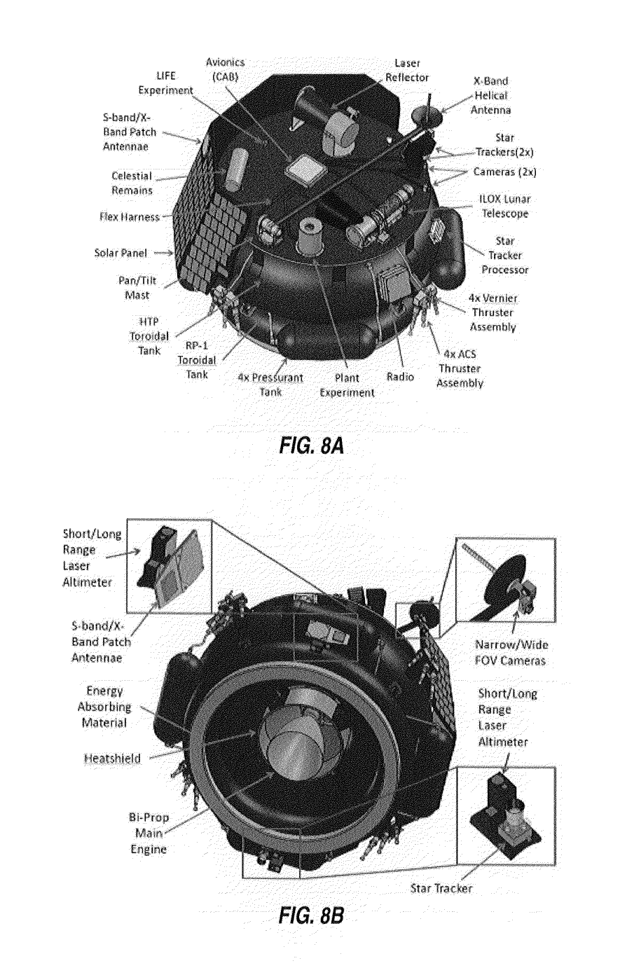

Modern advanced composite techniques for wrapping such shapes with carbon cloth over a lightweight substructure, known to those well versed in the art of advanced composites manufacturing, have made it possible to meet the design requirements ensuring that the tank is strong enough to withstand a variety of loads along all axes under time-varying thermal and inertial loading conditions incurred during travel to, through and from space, including touchdown, extended surface operation, and ascent phase off the body where operations are conducted. While designing the tank for strength, the shape and composite fiber orientation also inherently provide for a stiff structure. In addition, the structure contains a fluid that is an excellent vibration dampener. A low definition finite element model has been created to perform preliminary analysis. A representative static load in the thrust direction was placed on the lander to assess the launch vehicle structure interface. Initial results indicate a max stress within design tolerances for a 6061-T6 aluminum launch vehicle adapter cone, described below. Static load analysis and modal analysis, shown in FIGS. 7A and 7B respectively, show a first mode of 25 Hz which is a rocking mode of the launch vehicle adapter cone. FIGS. 8A and 8B are views of an embodiment of the spacecraft of the present invention.

The propulsion system is utilized in many phases after separation from the launch vehicle, The propulsion system of embodiments of the present invention preferably provide the necessary propulsive maneuvers to set the spacecraft on a trajectory which will cause it to arrive, for example, at the moon (trans-lunar injection, or TLI), lunar trajectory correction maneuvers (TCM's), braking, and final approach to touchdown. The propulsion system is also preferably capable of a re-start after landing on the surface of the Moon and provides enough thrust for lift-off and translation to a new location 500 meters away. The hydrogen peroxide as well as optional cold gas propulsion systems are based on advancing heritage products and technology that supported past programs like Mercury, Redstone, X-15, Soyuz, and various spacecraft reliably using these systems even today.

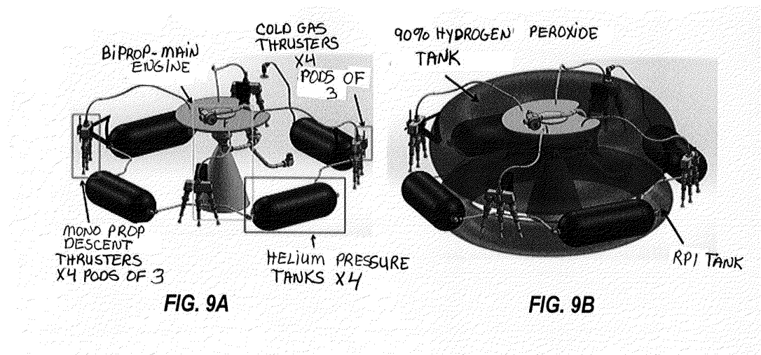

An embodiment of the baseline spacecraft propulsion system, shown in FIGS. 9A and 9B, preferably comprises a series of vertically stacked insulated toroidal propellant tanks, preferably ranging in outer diameter from about 45 to 55 inches. Cylindrical tanks preferably distributed around the perimeter of the toroid carry the pressurant. The upper toroidal tank preferably contains 90% hydrogen peroxide (HTP) and the lower toroidal tank preferably contains a rocket grade kerosene-like fuel, RP1. The cylindrical tanks preferably contain high-pressure gas (helium) for tank pressurization, valve actuation, and cold-gas thrust maneuvers. All tanks are preferably secured together mechanically and the main toroidal tank provides the primary structure for the spacecraft. It is the structural element through which substantially all structural launch loads, thrust loads, payload loads, and landing loads are transmitted and managed.

Most spacecraft ΔV (a measure of the change in velocity that is needed to change from one trajectory to another by making an orbital maneuver) is generated by a bi-propellant thruster that is located along the spacecraft vertical centerline of the toroidal propellant tanks and directly below the top deck. In an embodiment of the present invention, the upper toroidal tank preferably contains 90% hydrogen peroxide (HTP) and the lower toroidal tank preferably contains RP1, Four tanks containing high-pressure gaseous helium for tank pressurant, valve actuation, and cold gas thrust purposes are preferably attached to the upper toroidal tank, although any number of such tanks may be used. Located around the perimeter of the tanks are HTP mono-propellant attitude control thrusters (ACS) and optional GHe cold gas micro-thrusters (MTS), preferably twelve each (although any number may be used). Associated tubing, valves and cabling are preferably routed inside the core of the toroidal tanks and around their perimeter. The thrusters are preferably arranged in four pods of three ACS/three MTS each located at 90 degree quadrants around the perimeter of the HIP tank and oriented in a configuration for optimized attitude control. The twelve ACS thrusters are preferably oriented axially and off-axis so as to provide translational ΔV for low thrust guidance maneuvers and the twelve MTS thrusters are preferably oriented to provide local maneuvering of the vehicle during coast phase. In one embodiment, the spacecraft system mass when wet is approximately 600 kg, with a usable propellant mass of approximately 400 kg. The thrusters are preferably pulse width modulated and therefore do not have variable thrust levels. The spacecraft of the present invention preferably has the ability to do course corrections, a braking burn, and landing using an onboard propulsion system. The spacecraft bi-prop propulsion subsystem can provide 3-axis control to the spacecraft with thrusters during post-braking stage operation including descent, approach and terminal landing.

In some embodiments the entire spacecraft is designed to fit within the diameter of a standard ESPA (Evolved Expendable Launch Vehicle (EELV) Secondary Payload Adapter) ring envelope (56″ diameter) with an overall not-to-exceed mass of 600 kg, including both spacecraft mounting structure and flyaway mass. The spacecraft preferably utilizes state-of-the-art composite construction to provide a high specific-stiffness spacecraft. However, it also preferably utilizes the anisotropic nature of composites to create flexures and supports that are tailored to the specific loads acting upon the structural member, providing strength in the main loading direction with minimal strength in non-load bearing directions.

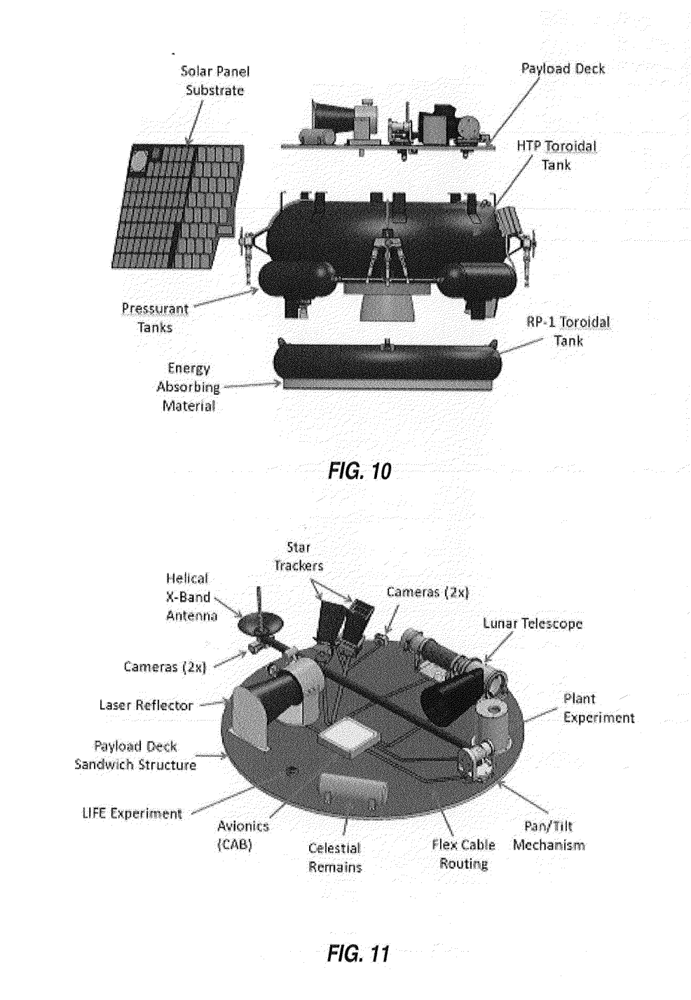

The primary structural element of the spacecraft is preferably the HTP toroidal tank. It serves as the mounting interface for secondary and tertiary structures, such as support struts, payload deck, solar panels, and RP1/pressurant tanks, which are preferably attached to the HTP tank as shown in FIG. 10. The HTP toroidal tank is both the primary structure and the main propulsion element and must be able to withstand internal pressure loads in addition to the normal loads that a typical primary structure must manage. Therefore, it is important to design the tank to not only handle pressure loading, but also launch, thruster firing, and landing loads. During launch, the tank will preferably be at a service pressure of 100 psi, allowing it to handle dynamic and quasi-static launch loads without being fully pressurized. After separation from the launch vehicle, the system is then fully pressurized preferably by firing a pyrotechnic valve. The HTP toroidal tank preferably serves as the mounting interface for the main bi-prop engine, ACS coarse thruster pods, pressurant tanks, RP-1 toroidal tank, and payload deck.

The payload deck, depicted in FIG. 11, preferably comprises a ridged lightweight aluminum honeycomb core closed out by unidirectional carbon fiber/epoxy lamina in a quasi-isotropic orientation. In addition to serving as the mounting interface for the payloads, the payload deck also supports one or more of the following: star trackers, inertial measurement units, antennae, and avionics.

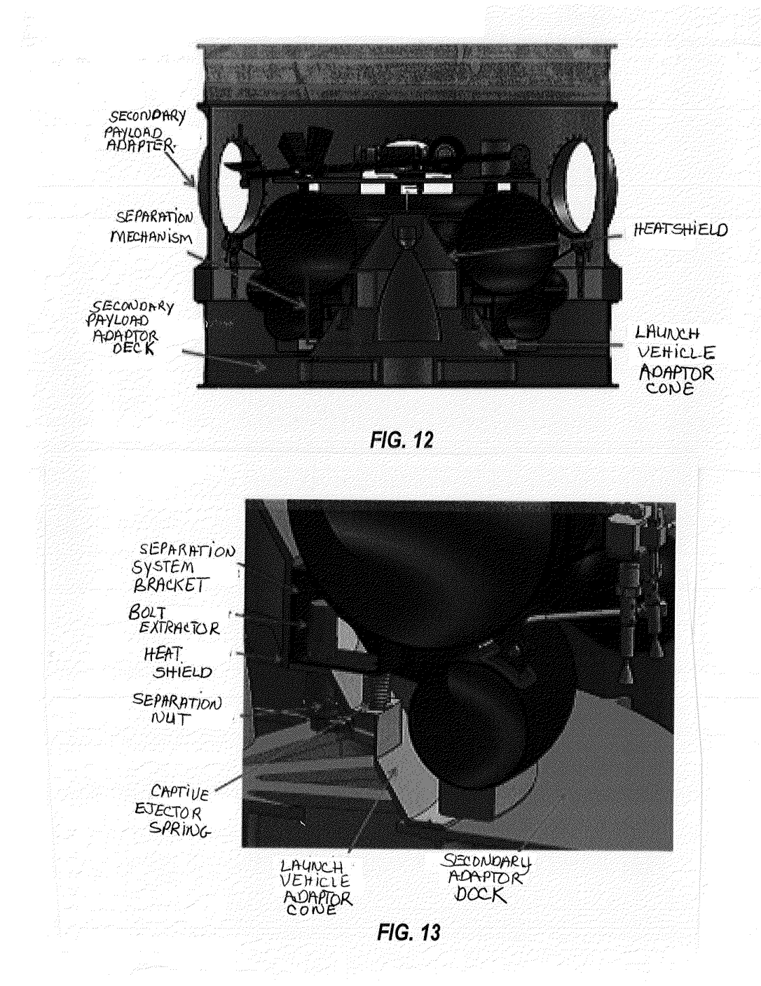

The interface to the launch vehicle preferably comprises an aluminum adapter cone that mounts to existing holes in the secondary spacecraft structure deck. The cone contains threaded inserts so that the spacecraft can be bolted to the secondary deck from underneath. The deck is a flight proven design that has been analyzed for spacecraft up to 1000 kg. FIG. 12 depicts the spacecraft within a dual payload adaptor system of a host launch vehicle, which preferably is located beneath the primary payload.

As shown in FIG. 13 the conical structure is attached to the spacecraft with a pyrotechnic separation nut and captive ejector spring, all of which are left on the launch vehicle after separation. On the spacecraft side, a bolt extractor and launch adapter bracket are used to interface to the cone. The bolt extractor is a spring-loaded mechanism that ensures the bolt is extracted and secured upon deployment. Once the bolts are extracted, the ejector springs provide a controlled separation from the launch vehicle. The springs are captivated such that they stay with the launch vehicle upon ejection.

Although the invention has been described in detail with particular reference to the described embodiments, other embodiments can achieve the same results. Variations and modifications of the present invention will be obvious to those skilled in the art and it is intended to cover all such modifications and equivalents. The entire disclosures of all patents and publications cited above are hereby incorporated by reference.

What is claimed is:

1. A spacecraft for which the primary structural component comprises a propellant tank for carrying a first propellant.

2. The spacecraft of claim 1 wherein said propellant tank is toroidal.

3. The spacecraft of claim 1 comprising one or more secondary structures selected from the group consisting of a second propellant tank, one or more pressurant tanks, a main engine, a payload deck, and one or more attitude control engines;
wherein said secondary structures are attached directly to said propellant tank.

4. The spacecraft of claim 3 wherein said attitude control engine are operated via pulse width modulation.

5. The spacecraft of claim 1 comprising a substantially circularly symmetric weight distribution about its centerline.

6. The spacecraft of claim 1 comprising a single stage propulsive system.

7. The spacecraft of claim 1 wherein said propellant tank is designed to carry high-test peroxide.

8. The spacecraft of claim 1 comprising a monopropellant propulsion system.

9. The spacecraft of claim 1 comprising a bipropellant propulsion system and a second propellant tank for carrying a second propellant;

10. The spacecraft of claim 9 wherein said second propellant comprises kerosene or ethanol.

11. The spacecraft of claim 9 wherein said second propellant tank is toroidal and concentrically nests together with said propellant tank.

12. The spacecraft of claim 11 wherein said second propellant tank is attached below said propellant tank and has a circumference greater than that of said propellant tank.

13. The spacecraft of claim 9 wherein said first propellant comprises an oxidizer and said second propellant comprises a fuel.

14. The spacecraft of claim 13 wherein said bipropellant propulsion system operates at an oxidizer to fuel mixture ratio that is greater than approximately three to one.

15. The spacecraft of claim 14 wherein said bipropellant propulsion system operates at an oxidizer to fuel mixture ratio that is greater than approximately six to one.

16. The spacecraft of claim 9 wherein said propulsion system is switchable between monopropellant operation and bipropellant operation.

17. The spacecraft of claim 16 wherein said propulsion system automatically switches to monopropellant operation after depletion of one of said propellants.

18. The spacecraft of claim 17 wherein said depleted propellant comprises a fuel.

19. The spacecraft of claim 1 comprising an outer mold line that mates with a circular inner wall of a housing for mounting within a launch vehicle, thereby optimizing launch vehicle payload volume and facilitating stacking of multiple housings in the bunch vehicle.

20. The spacecraft of claim 1 wherein said propellant tank comprises a composite material.
